(19) United States
(12) Patent Application Publication
(10) Pub. No.: US 2009/0038941 A1
(43) Pub. Date: Feb. 12, 2009

(54) Device for Determining the Concentration of a Component in a Gas Mixture

(75) Inventors: Roland Stahl, Freiberg (DE); Hans-Martin Wiedenmann, Stuttgart (DE); Detlef Heimann, Gerlingen (DE); Lothar Diehl, Gerlingen (DE); Thomas Moser, Schwieberdingen (DE); Bjoern Janetzky, Ditzingen (DE); Jan Bahlo, Pforzheim (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 11/632,142

(22) PCT Filed: Jun. 23, 2005
(86) PCT No.: PCT/EP2005/052936

§ 371 Date: Jan. 10, 2007

(30) Foreign Application Priority Data
Aug. 31, 2004 (DE) 10 2004 042 027.0

(51) Int. Cl. G01N 27/419; G01N 27/407; G01N 27/406

(52) U.S. Cl. 204/424

(57) ABSTRACT

In an apparatus that ascertains a concentration of a component in a gas mixture, the apparatus includes:
a gas measurement chamber, in which the concentration of the component is adjustable against an influence of an interface, acting across a diffusion barrier, with the concentration in the gas mixture,
whereby the influence of the interface is compensated for by a controllable current of ions of the component by way of a solid electrolyte, which is charged with a controllable pumping voltage, serves as a pumping mechanism, and is located between the gas measurement chamber and the gas mixture, so that a parameter that characterizes a current constitutes a measurement for the concentration in the gas mixture, whereby
the solid electrolyte is at least periodically charged with a specified constant pumping voltage as a function of at least one state parameter of the gas mixture.

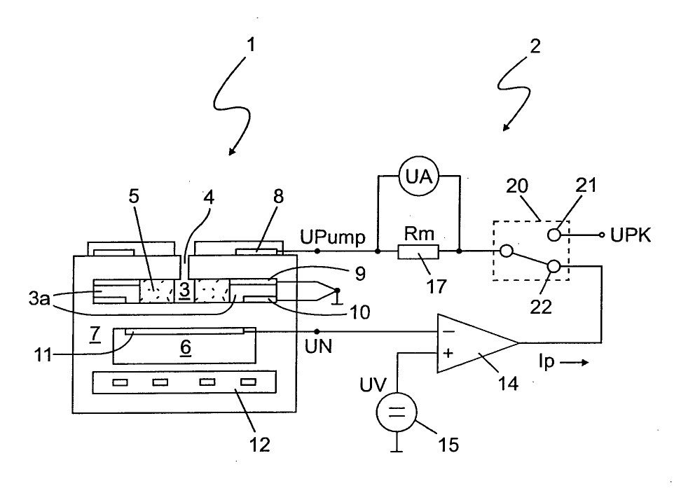

### STATE OF THE ART

The invention concerns a device to ascertain the concentration of a component in a gas mixture, especially the oxygen concentration in the exhaust gas of internal combustion engines according to the class of claim 1.

Such a device is known from the German patent DE 195 16 139 A1.

From the German patent DE 198 57 471 A1 a sensor element emerges for limit current sensors to determine the lambda values of gas mixtures, especially of exhaust gases of internal combustion engines, whereby the sensor element is designed with inner and outer pumping electrodes disposed on a solid electrolyte foil. The inner pumping electrode is disposed in a diffusion channel bordered by a diffusion barrier. The pumping electrode lies behind the diffusion barrier in the direction of diffusion of the gas mixture. An access hole for the gas is directed essentially vertical to the surface area of the solid electrolyte foil and through the same into the diffusion channel. The diffusion barrier is disposed in the diffusion channel back from the inner wall of the access hole for the gas. Thus, a larger entrance surface results, whereby the baking of deposited exhaust gas components is avoided during a delayed activation after starting the internal combustion engine.

Especially if the oxygen concentration in the exhaust gas of internal combustion engines is supposed to be determined, pressure peaks can arise in the gas mixture, which is to be detected. In this instance an additional amount of gas is thrust into the gas measurement space, whereby a short increase in the amount of the positive or negative pumping electricity is precipitated. In the instance where an oxygen concentration is detected in the exhaust gas of an internal combustion engine, the sensitivity of the device is inflated above the calibrated value, whereby mistaken values of oxygen concentration are indicated. The reason for this lies therein, that the resistance of a diffusion barrier, which is disposed between the first partial volume and the second partial volume, is too small for a stream due to a pressure gradient in comparison to the resistance due to a diffusion, i.e. a particle migration as a result of a concentration gradient. Thus, pressure peaks change the output signal, for example as a result of the combustion chamber of the internal combustion engine being emptied, although this is not necessarily connected with a change of the gas composition. Especially in that instance, when the oxygen concentration is recorded in the exhaust gas of internal combustion engines, partial pressure fluctuations become readily apparent at high concentrations of oxygen in the first partial volume due to the inflowing exhaust gas. The extent of the fluctuations of the output voltage is in this case proportional to the partial pressure of oxygen in the exhaust gas and thereby proportional to the pumping electricity. These phenomena are denoted as dynamic pressure dependence. If the gas escapes out of the diffusion barrier with an elevated concentration of oxygen by means of a pressure surge, it disperses immediately into the whole cavity and is pumped out. Therefore, it cannot be removed again during a reverse pressure surge, which once again leads to an imbalance of the dynamic dependence, which also cannot be removed by means of electronic filters and the like. At low pressure surge frequencies a considerable part of the gas which has flowed in can be removed. If no cavity exists a concentration gradient results along the electrodes, which causes an irregular stress of the pumps and electrodes.

The task underlying the invention is to further configure a device, which is described at the beginning of the application, to ascertain the concentration of a component in a gas mixture—especially the concentration of oxygen in the exhaust gas of an internal combustion engine—to such an extent, that the previously described pressure peaks in the gas mixture do not negatively affect the parameter, which characterizes the pumping electricity and serves as a measurement of the sought-after concentration.

### ADVANTAGES OF THE INVENTION

This task is solved according to the invention by a device to ascertain the concentration of a component in a gas mixture with the characteristics of the claim 1.

It is the basic idea of the invention, to charge the solid electrolyte at least periodically, that is to say intermittently, as a function of a state parameter with a specified constant pumping voltage. In so doing, the limit current flows in each case according to the concentration of the component of the gas mixture, i.e., for example, according to the concentration of oxygen in the cavity. In this manner the dynamic of the reaction is determined only by way of the gas stream over the diffusion barrier.

The state parameter, of which there must be at least one, can, for example, be the prevailing pressure in the gas mixture.

In another example of embodiment the state parameter can, however, also be the concentration of the component. In so doing a device configured as a wideband sensor is operated periodically in the lean operation as a limit current sensor. By way of such a method of operation, quick reactions produced by pressure impulses are avoided, so that the output signal corresponds considerably better to the actual concentration of the component in the gas mixture.

A particularly advantageous form of embodiment is realized by a switching medium of the pumping voltage between a terminal, at which the specified constant pumping voltage lies, and a switching mechanism, through which the pumping voltage is controlled by a set point as a function of the deviation of the output voltage of a Nernst cell between the first partial volume and an area, in which a reference concentration of the component of the gas mixture is present. This advantageous form of embodiment allows for the operation of the device as both an inherently known wideband sensor and periodically as a limit current sensor.

### DRAWING

Additional advantages and characteristics of the invention are subsequently explained by means of an example of embodiment of the invention, which is depicted in the FIGURE. The FIGURE shows a device according to the invention to ascertain the concentration of a component in the gas mixture.

### EXAMPLE OF EMBODIMENT

The device depicted in the FIGURE consists of a sensor 1 and a switching mechanism 2 of the sensor 1. The sensor 1 has a first partial volume 3, that is connected with a gas mixture, for example the exhaust gas of an internal combustion engine, by way of a small opening 4, which acts as a resistance to diffusion. In a second partial volume 6 a reference atmosphere prevails, which, for example, can be defined through a connection to the outside air or created in another fashion. Both partial volumes are bordered by an electrolyte 7, which conducts oxygen ions and carries electrodes 8, 9, 10 and 11. Provision can be made for a heater 12 in the electrolyte 7.

Additionally a diffusion barrier 5 is disposed in the partial volume 3. It is disposed between the cavity, into which the gas mixture flows via the opening 4, and a gas measurement chamber 3a, in which the electrodes 8, 9 are provided. The Nernst voltage UN, which appears in the gas measurement chamber 3a and in the partial volume 6 as a result of differing oxygen concentrations, is fed to an inverting input of an operational amplifier 14, at whose non-inverting input a specified reference voltage UV of, for example, 450 mV, lies. It (the reference voltage) is, for example, produced by a voltage source 15. A set point for the oxygen in the gas measurement chamber 3a is established with the reference voltage UV. At a Nernst voltage UN smaller than 450 mV the output of the operational amplifier 12 becomes positive and drives a positive current I_{P} through the pumping cell which is constituted by the electrodes 8, 9 and the electrolyte 7 lying between them. Or expressed differently: a comparatively small Nernst voltage UN, which corresponds to an oxygen surplus in the gas measurement chamber 3a, leads to a transport of (negative) oxygen ions from the gas measurement chamber 3a to the exhaust gas. A comparatively high Nernst voltage leads accordingly to a stream of oxygen particles from the exhaust gas to the gas measurement chamber 3a, so that in the steady state a specified concentration of oxygen appears in the gas measurement chamber 3a. As this concentration is disrupted by the interface acting across the diffusion barrier 5, the necessary pumping current I_{P} for maintenance of the concentration represents ultimately a measurement for the oxygen concentration in the exhaust gas. The pumping current I_{P} can be measured as a drop in current across a measurement resistance Rm 17, as depicted in the figure.

A medium 20, configured after the operational amplifier 14, for switching between a terminal 21, which will be dealt with subsequently in more detail, and a terminal 22, which is connected to the output of the operational amplifier 14.

In the switching position shown in the figure, in which the output of the operational amplifier 14 is connected to the outer pumping electrode 8, at which thus a controllable pumping voltage UPump lies, by way of a measurement resistance 17, the device is operated as an inherently known wideband sensor, as it, for example, emerges from the German patent DE 198 57 471 A1, which was referred to earlier. In this case the voltage signal UA tapped across the measurement resistance Rm 17 is a measurement for the concentration of the component of the gas mixture, that is to say, for example, of the oxygen concentration of the exhaust gas.

When pressure impulses occur in the exhaust gas, an additional amount of gas is in each case thrust into the cavity 3 as well as the gas measurement chamber 3a, whereby a short increase in the amount of the positive or negative pumping current I_{P} is induced, i.e. a deviation, for example, from the Lambda value=1 in the case of the measuring of the oxygen concentration. This is due to the fact, that the resistance of the diffusion barrier 5 is too small for a stream as a result of a pressure gradient—in comparison to the resistance as a result of a diffusion—of a particle migration induced by a concentration gradient. Thereby pressure peaks appear as the output signal due to the combustion chamber being emptied, which are not necessarily connected to a change of the gas composition, for example, a change of the oxygen concentration and with it a change of the Lambda value. This phenomenon is denoted as a dynamic pressure dependence.

Especially in the case of a high oxygen partial pressure, the partial pressure fluctuation in the cavity 3 as well as in the gas measurement chamber 3a has a strong impact due to the exhaust gas flowing in by way of the opening 4. The extent of the fluctuations of the output voltage UA is proportional to the oxygen partial pressure or the pumping current I_{P}. If the gas escapes with a high oxygen concentration out of the diffusion barrier 5 by way of a pressure surge, it disperses itself immediately in the entire gas measurement chamber 3a. For this reason it can not be immediately removed again during a reverse pressure surge, so that imbalances of the dynamic pressure dependence arise, which also cannot be eliminated by electronic filters.

In contrast, in the case of low frequencies of pressure surge, a considerable amount of the gas, which has flowed in, can be removed by the pump electrodes 8, 9 even during a half-wave.

In order to eliminate these problems, provision is made for a second switching position of the medium 20 for performing commutation, in which the outer measurement electrode 8 is connected to a terminal (port) 21, at which a positive constant pumping voltage UPK lies. The limit current flows at any one time through this terminal corresponding to the concentration of the component, for example the oxygen concentration in the gas measurement chamber 3a. The dynamic of the reaction is determined only by the gas flow across the diffusion barrier 5. The wideband sensor is, therefore,—expressed another way—operated periodically as a limit current sensor. In so doing, an operational method is avoided, during which quick reactions to pressure impulses are produced. The output signal UA corresponds so significantly better to the actual exhaust gas concentration. At the same time as depicted in the figure, provision can be made for an additional port 21. However, the pumping voltage can also be commutated internally in an integrated circuit. Likewise the entire circuitry 2 can be part of an integrated circuit or part of a control device. In this case the limit current is a measurement for the oxygen concentration in the exhaust gas.

1. An apparatus that ascertains a concentration of a component in a gas mixture, the apparatus includes:
a gas measurement chamber, in which the concentration of the component is adjustable against an influence of an interface, acting across a diffusion barrier, with the concentration in the gas mixture,
whereby the influence of the interface is compensated by a controllable current of ions of the component by way of a solid electrolyte, which is charged with a controllable pumping voltage, serves as a pumping mechanism, and is located between the gas measurement chamber and the gas mixture, so that a parameter that characterizes a current constitutes a measurement for the concentration in the gas mixture, whereby
the solid electrolyte is at least periodically charged with a specified constant pumping voltage as a function of at least one state parameter of the gas mixture.

2. An apparatus according to claim 1, wherein the at least one state parameter is a prevailing pressure in the gas mixture.

3. An apparatus according to claim 1, wherein the at least one state parameter is the concentration of the component.

4. An apparatus according to claim 1, further including a medium to commutate the pumping voltage between a terminal, at which the specified constant pumping voltage lies, and a switching mechanism, through which the pumping voltage is controlled by a set point as a function of the deviation of the output voltage of a Nernst cell between a first partial volume and an area, in which the reference concentration of the component of the gas mixture is present.

5. An apparatus according to claim 1, wherein the concentration is an oxygen concentration in the exhaust gas of an internal combustion engine.
